(19) United States
(12) Patent Application Publication
(10) Pub. No.: US 2006/0198721 A1
(43) Pub. Date: Sep. 7, 2006

(54) Method and apparatus for unloading hopper cars

(76) Inventor: Robert Flournoy Harrold, Christi, TX (US)

Correspondence Address: GEORGE S. GRAY, P.O. BOX 270190, CORPUS CHRISTI, TX, 78427-0190, US

(21) Appl. No.: 10/559,099

(22) PCT Filed: Jun. 2, 2004
(86) PCT No.: PCT/US04/17596

§ 371 Date: May 1, 2006

Related U.S. Application Data
(60) Provisional application No. 60/475,427, filed on Jun. 2, 2003.

(51) Int. Cl. B65F 9/00

(52) U.S. Cl. 414/378

(57) ABSTRACT

A hopper car unloading apparatus is provided for transporting materials discharged through hoppers on a rail hopper car. As installed, a movable track member replaces a section of track and has an aligned position for the car to roll over and straddle the track member, the car's wheel sets then positioned on adjacent fixed tracks. The track member is then displaced by hydraulic power equipment, and a receiving deck is moved into a receiving position under the car, to receive materials discharged through the hoppers and transports the material out from under the car for discharge onto a takeaway conveyor. Embodiments include different numbers of conveyor sections in the receiving deck. Embodiments include paired track member sections and receiving deck sections, each pair moving independently of other paired track member and receiving deck sections. Embodiments include control of the track member and receiving deck movements from an operator station.

### REFERENCE TO PRIOR APPLICATION

Applicant claims the benefit, to the full extent possible, of the effective filing date of a provisional application filed in the United States Patent and Trademark Office on 2 Jun. 2003 (Jun. 2, 2003), having application No. 60/475,427, filed by the above-named inventor.

### TECHNICAL FIELD

The field of the invention is railroad hopper cars, and more particularly, unloading materials such as coal, petroleum coke, barite, etc. through the hoppers and conveying the materials from beneath the hopper car.

### BACKGROUND ART

The rail transfer of materials, such as coal, petroleum coke, barite and other bulk solids is largely conducted using hopper cars, from which the material is discharged through hoppers as hopper doors are opened through the bottom. Current installations for receiving the material typically involve extensive pit excavations below surface level, with extensive underground and surface equipment requirements. In some installations, entire hopper cars are inverted by rotation requiring a very large scale and expensive operation. The extensive pit excavation and equipment requirements for current hopper car unloading techniques are a stumbling block to smaller companies or companies wanting to build their own unloading facilities for amounts of materials that would not economically justify the installation expense. What is needed is an apparatus, of smaller scale than currently available equipment, that maximizes the clearance between the hopper and the ground underneath and surrounding the hopper car, and minimizing or eliminating excavation.

### DISCLOSURE OF THE INVENTION

The present invention provides compact, modular apparatus and methods for retracting a section of track from beneath the hopper car, the track section extending under all the hoppers, but stopping before the hopper car wheels. The hopper car wheels remain on conventional track structure at each end of the special retractable track section. A receiving deck with multiple conveyor sections is placed underneath the hoppers, such that the hoppers discharge directly onto the receiving deck, which in turn conveys the material to a takeaway conveyor running alongside the installation.

A hopper car unloading apparatus is provided for transporting materials discharged through hoppers on a rail hopper car, the car having a first end wheel set and a second end wheel set, the wheel sets being positionable on fixed tracks adjacent the apparatus, the apparatus comprising: a movable track member, the track member being movable from and to an aligned position wherein the track member is aligned with the fixed tracks such that the car wheel sets are rollable over the track member; and a receiving deck having a head portion, the receiving deck being movable to and from a receiving position beneath the car for receiving the materials discharged through the hoppers, the receiving deck transporting such received materials from beneath the car for discharge at the head portion, the track member being out of its aligned position when the receiving deck is in the receiving position.

I have provided a hopper car unloading apparatus for transporting materials discharged through hoppers on a rail hopper car, the car having a first end wheel set and a second end wheel set, the wheel sets being positionable on fixed tracks adjacent the apparatus, the apparatus comprising: a track member, the track member being between the first end and second end wheel sets, the track member being movable from a first position in which the track member is substantially aligned with the fixed tracks such that the car wheel sets can roll onto the track member from the fixed tracks, to a second position, such that the track member is substantially out from under the hoppers; and a receiving deck, the receiving deck having a head portion, the receiving deck being movable from a first position to a second position, wherein at least part of the receiving deck is beneath at least one hopper along substantially the entire at least one hopper length, the receiving deck and the track member cooperating for coordinated movement between the first and second positions of each; such that, when the track member is in the second position and materials are discharged through the at least one hopper above the receiving deck, the materials are transported by the receiving deck for discharge at the receiving deck head portion.

In some exemplary embodiments, the receiving deck further comprises at least two conveyor sections.

In some exemplary embodiments, the track member further comprises at least two sections, and the receiving deck further comprises at least two sections, each track member section cooperating with a receiving deck section, for coordinated movement between the first and second positions of each, the movement being optionally independent of movement by other track member sections and other receiving deck sections.

In some exemplary embodiments, each receiving deck section further comprises at least two conveyor sections.

In some exemplary embodiments, the apparatus further comprises a takeaway conveyor, the takeaway conveyor being positioned to receive materials discharged at the receiving deck head portion.

In some exemplary embodiments, the apparatus further comprises a second like apparatus positioned for receiving discharged materials from a second rail hopper car's hoppers, the takeaway conveyor for each apparatus discharging received materials onto a common conveyor.

In some exemplary embodiments, the apparatus further comprises electronic control of the coordinated movement of the track member and the receiving deck.

In some exemplary embodiments, the apparatus further comprises an operator control station from which an operator operates the electronic control of the coordinated movement of the track member and the receiving deck.

In some exemplary embodiments, while the receiving deck is in the second position, the at least one hopper above the receiving deck is a paired hopper, and at least part of the receiving deck is beneath substantially the entire combined length of the paired hoppers.

In some exemplary embodiments, the track member has a first rail and a second rail, each rail for receiving the car wheel sets, the first rail and second rail being moved closer together when the track member is moved from the first position.

My invention provides a hopper car unloading apparatus for transporting materials discharged through hoppers on a rail hopper car, the car having a first end wheel set and a second end wheel set, the wheel sets being positionable on fixed tracks adjacent the apparatus, the apparatus comprising: a movable track member; means for moving the track member from and to an aligned position wherein the track member is aligned with the fixed tracks such that the car wheel sets are rollable over the track member; a receiving deck having a head portion; and means for moving the receiving deck to and from a receiving position beneath the car for receiving the materials discharged through the hoppers, the receiving deck transporting such received materials from beneath the car for discharge at the head portion, the track member being out of its aligned position when the receiving deck is in the receiving position.

I have provided a hopper car unloading apparatus for transporting materials discharged through hoppers on a rail hopper car, the car having a first end wheel set and a second end wheel set, the wheel sets being positionable on fixed tracks adjacent the apparatus, the apparatus comprising: a track member, the track member being between the first end and second end wheel sets; means for moving the track member a first position in which the track member is substantially aligned with the fixed tracks such that the car wheel sets can roll onto the track member from the fixed tracks, to a second position such that the track member is substantially out from under the hoppers; a receiving deck, the receiving deck having a head portion; and means for moving the receiving deck from a first position to a second position wherein at least part of the receiving deck is beneath at least one hopper along substantially the entire at least one hopper length, the means for moving the receiving deck and the means for moving the track member cooperating for coordinated movement of the receiving deck and the track member between the first and second positions of each; such that when the track member is in the second position and materials are discharged through the at least one hopper above the receiving deck, the materials are transported by the receiving deck for discharge at the receiving deck head portion. In some exemplary embodiments, the means for moving the receiving deck is a direct linkage of the receiving deck to the track member.

A method is provided for transporting materials discharged through hoppers on a rail hopper car, the car having a first end wheel set and a second end wheel set, the wheel sets being positionable on fixed tracks adjacent the apparatus, the method comprising the steps of: positioning the car on the fixed tracks while the track member is in an aligned position wherein it is aligned with the fixed tracks, such that the car wheel sets are rollable over the track member, the car wheels utilizing the track member for such positioning; moving the track member to a non-aligned position; moving a receiving deck, having a head portion, to a receiving position beneath the car; receiving materials discharged through the at least one hopper onto the receiving deck; transporting the discharged materials on the receiving deck for discharge at the receiving deck head portion; removing the receiving deck from its receiving position; returning the track member to its aligned position; and moving the hopper car from above the track member, the hopper car wheels utilizing the track member during such movement. In some exemplary embodiments, a second car is coupled to the unloaded car, and the method further comprises repeating the foregoing steps for the second car, the step of positioning the car on the fixed tracks occurring as the first car was removed from above the track member. In some exemplary embodiments, the apparatus further comprises the step of receiving the discharged materials from the receiving deck onto a takeaway conveyor.

I have provided a method for transporting materials discharged through hoppers on a rail hopper car, the car having a first end wheel set and a second end wheel set, the wheel sets being positionable on fixed tracks adjacent the apparatus, the method comprising the steps of: positioning the car on the fixed tracks such that the car hoppers are above a track member, the track member being movable from first position under the hoppers to a second position substantially out from under the hoppers, the car wheels utilizing the track member for such positioning; moving the track member to the second position; moving a receiving deck, having a head portion, from a first position wherein the receiving deck is substantially out from under the hoppers, to a second position wherein at least part of the receiving deck is beneath at least one hopper along substantially the entire hopper length; receiving materials discharged through the at least one hopper onto the receiving deck; transporting the discharged materials on the receiving deck for discharge at the receiving deck head portion; returning the receiving deck to its first position; returning the track member to the first position; and moving the hopper car from above the track member, the hopper car wheels utilizing the track member during such movement. In some exemplary embodiments, a second car is coupled to the unloaded car, and the method further comprises repeating the foregoing steps for the second car, the step of positioning the car on the fixed tracks occurring as the first car was removed from above the track member. In some exemplary embodiments, the method further comprises the step of receiving the discharged materials from the receiving deck onto a takeaway conveyor.

### BRIEF DESCRIPTION OF DRAWINGS

FIG. 1 is a side view of the hopper car with doors open over a sectional view of the receiving deck and the conventional tracks adjacent the installation of an exemplary embodiment of the invention.

FIG. 2 is a side view of the receiving deck, takeaway conveyor, and operator station in an exemplary embodiment of the invention.

FIG. 3 is an end view of the takeaway conveyor and operator station in an exemplary embodiment of the invention.

FIG. 4 is a side view of portions of one receiving deck section in an exemplary embodiment of the invention, excluding the motor and gear reducer.

FIG. 5 is a top view of portions of one receiving deck section in an exemplary embodiment of the invention, excluding the motor and gear reducer.

FIG. 6 is an end view of portions of one receiving deck section in an exemplary embodiment of the invention, including the motor and gear reducer.

FIG. 7 is a top view of the receiving deck in an exemplary embodiment of the invention, excluding the motors, gear reducers, and arch shaped diverters.

FIG. 8 is a top view of portions of an exemplary embodiment of the invention, with the track member and receiving deck in the first position.

FIG. 9 is a sectional end view of portions of an exemplary embodiment of the invention, with the track member and receiving deck in the first position, the section taken at 9-9′ on FIG. 8.

FIG. 9a is a sectional end view of a lateral positioner.

FIG. 10 is a top view of portions of an exemplary embodiment of the invention, with the track member and receiving deck in the second position.

FIG. 11 is a sectional side view of portions of an exemplary embodiment of the invention, with the track member and receiving deck in the second position, the section taken at 11-11′ on FIG. 10.

FIG. 12 is a top view of the top pull members and the adjoining first and second rail support structures in an exemplary embodiment of the invention, when the track member is in the first position.

FIG. 13 is a top view of the lower pull members and the adjoining first and second rail support structures in an exemplary embodiment of the invention, when the track member is in the first position.

FIG. 14 is a side view, from the car far side of portions of the first rail support structure in an exemplary embodiment of the invention, illustrating the location of pin joints, slide channels and lateral positioner clearance notches. The vertical scale is enlarged for clarity.

FIG. 15 is a side view, from the car near side of portions of the second rail support structure in an exemplary embodiment of the invention, illustrating the location of pin joints, slide channels and hydraulic piston openings. The vertical scale is enlarged for clarity

FIG. 16 is a top view of portions of an exemplary embodiment of the invention, where two takeaway conveyors discharge onto a common conveyor.

FIG. 17 is a top view of portions of an exemplary embodiment of the invention, where the track member has two sections and the receiving deck has two sub-sections, the track member first section and being shown in the second position.

FIG. 18 is a top view of portions of the exemplary embodiment of the invention of FIG. 17, the receiving deck first sub-section being shown in the second position.

FIG. 19 is a top view of portions of an exemplary embodiment of the invention, where the track member rails do not close together in the second position.

FIG. 20 is a top view of the top pull members and the adjoining first and second rail support structures in an exemplary embodiment of the invention, when the track member is in the first position, and the pull members are perpendicular or substantially perpendicular to the rail support structures.

FIG. 21 is a top view of the lower pull members and the adjoining first and second rail support structures in an exemplary embodiment of the invention of FIG. 20, when the track member is in the first position, and the pull members are perpendicular or substantially perpendicular to the rail support structures.

FIG. 22 is a top view of portions an exemplary embodiment of the invention, where the track member is shown to move on guide tracks.

### MODES FOR CARRYING OUT THE INVENTION

The following discussion describes in detail exemplary embodiments of the invention. This discussion should not be construed, however, as limiting the invention to those particular embodiments. Practitioners skilled in the art will recognize numerous other embodiments as well.

### Definitions

Conventional hopper cars have both single and paired hoppers spaced along their length. The paired hoppers are side-by-side. As used herein, the term “HOPPERS” includes both single and paired hoppers, and a reference to a “first end hopper,” refers both to a single hopper extending across substantially the entire car width, and paired hoppers, each pair being spaced along the hopper car length.

### General

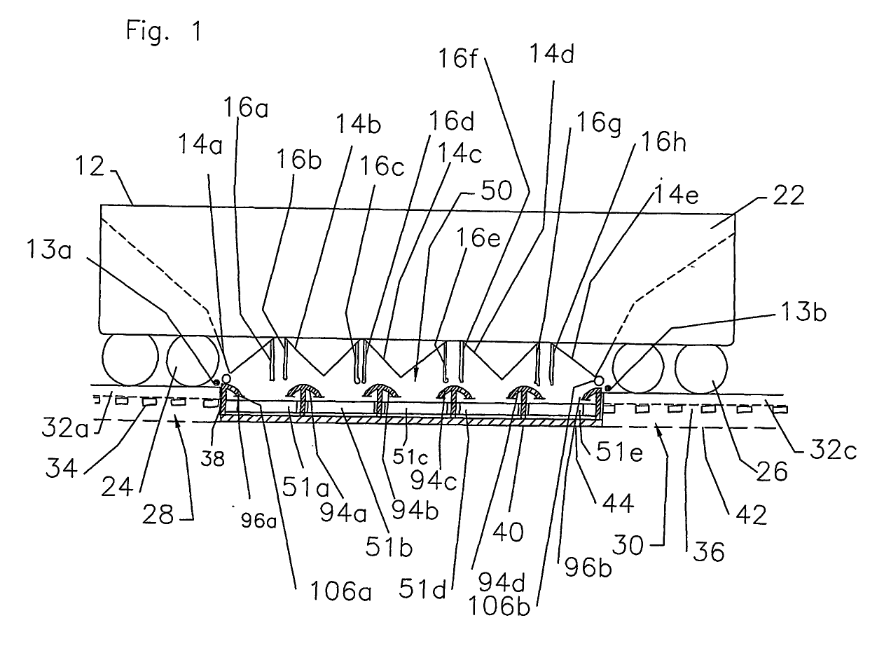

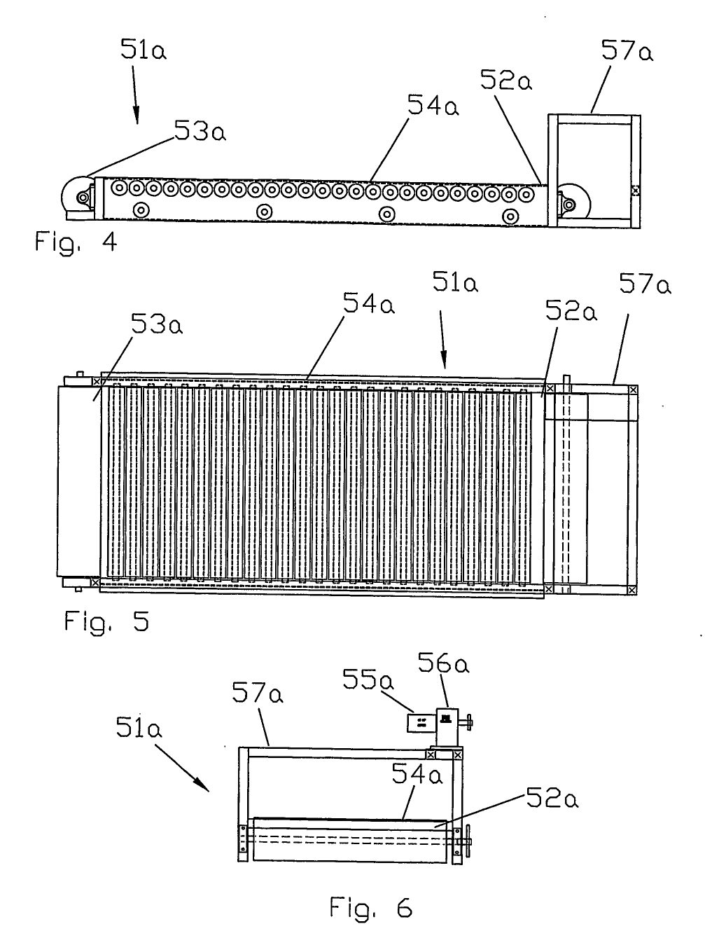

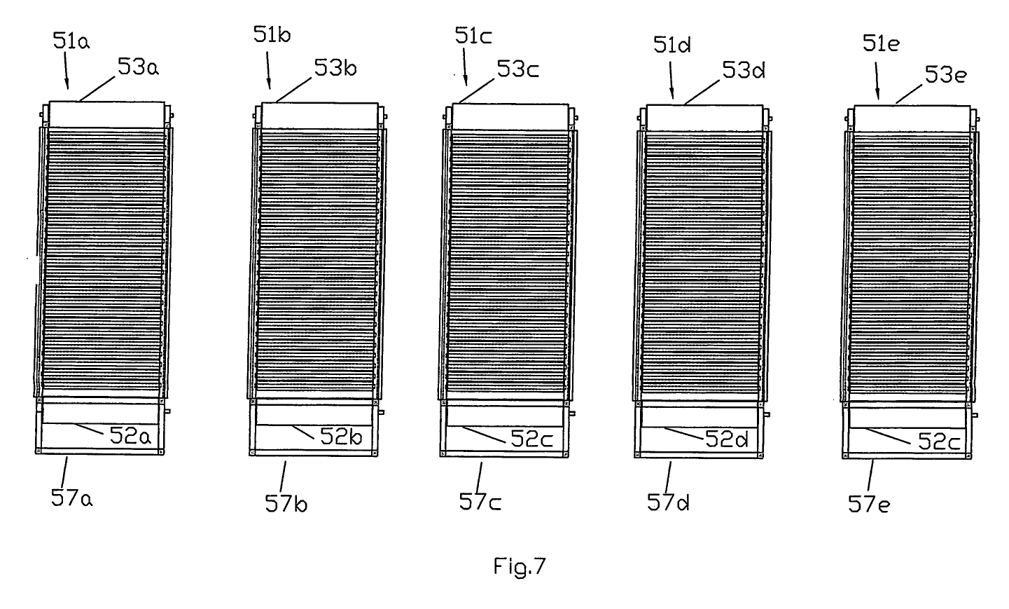

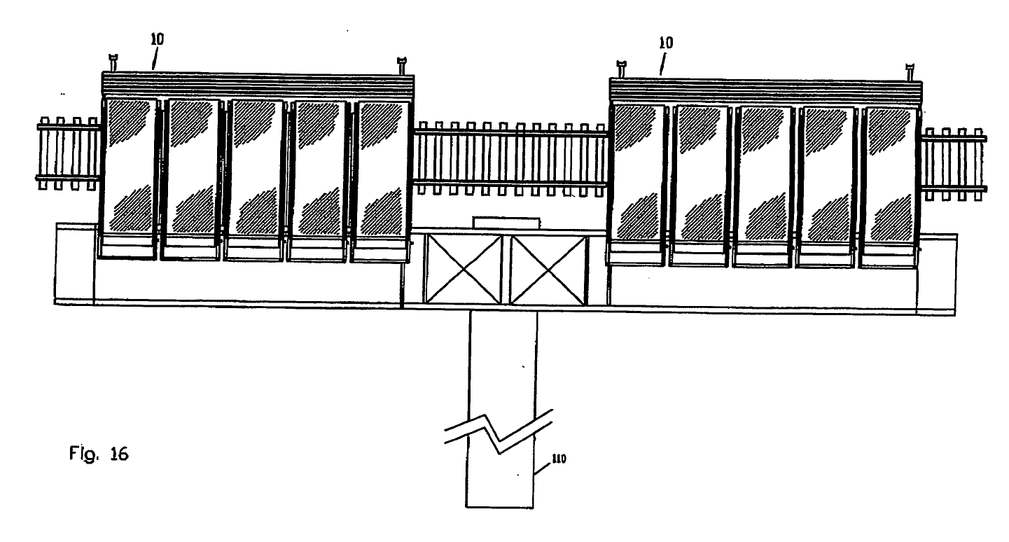

FIGS. 1-15 depict an exemplary embodiment of the current invention wherein the hopper car unloading apparatus 10 is shown in relation to a rail hopper car 12 having hoppers 14a-e, including a first end hopper 14a and a second end hopper 14e, with hopper doors 16a-h, the car having a far side 20 and a near side 22, and a first end wheel set 24 and a second end wheel set 26, the wheel sets being positioned on first end fixed tracks 28 and second end fixed tracks 30, respectively. The fixed tracks are typically constructed with ten inch (25.4 cm.) rails 32a-d affixed on ties 34 and ballast 36, the ties and ballast typically having a combined height of 14-20 inches (35.6-50.8 cm.). As shown in FIG. 1, the apparatus 10 installation typically includes removing the ballast and ties, thus creating an excavation 38 with a bottom 40 near the level of the ground 42 surrounding the tracks. In a typical operation, hopper doors 16a-h open, either manually or electronically, to allow gravity discharge of materials, e.g. coal, barite and the like.

In exemplary embodiments of the type illustrated in FIGS. 1-2 and FIGS. 4-7, the apparatus 10 is supported by a concrete base 44 and includes a conveyor assembly, referred to herein, as a receiving deck 50, with five conveyor sections 51a-e. In other exemplary embodiments, the base is constructed from other materials of sufficient strength, e.g. steel. In some such exemplary embodiments, the conveyor sections are a roller bed belt conveyors and the first conveyor section 51a has a head portion 52a, a tail portion 53a, a belt 54a, an electric motor 55a, a gear reducer 56a, and an open frame 57a on which the motor and gear reducer are positioned. Similarly, the second conveyor section 51b has a head portion 52b, a tail portion 53b, a belt 54b, an electric motor 55b, a gear reducer 56b, and an open frame 57b, the third conveyor section 51c has a head portion 52c, a tail portion 53c, a belt 54c, an electric motor 55c, a gear reducer 56c, and an open frame 57c, the fourth conveyor section 51d has a head portion 52d, a tail portion 53d, a belt 54d, an electric motor 55d, a gear reducer 56d, and an open frame 57d, and the fifth conveyor section 51e has a head portion 52e, a tail portion 53e, a belt 54e, an electric motor 55e, a gear reducer 56e, and an open frame 57e. Further, some exemplary embodiments have roller bed belt conveyors with a conventional larger diameter head (drive) pulley for extra traction and higher discharge height. In some exemplary embodiments, the conveyor belts are extra durable multi-ply construction to resist tearing and stretching, and in some exemplary embodiments the belts are vulcanized. In some exemplary embodiments, the belt can be tightened or realigned using a conventional tail pulley.

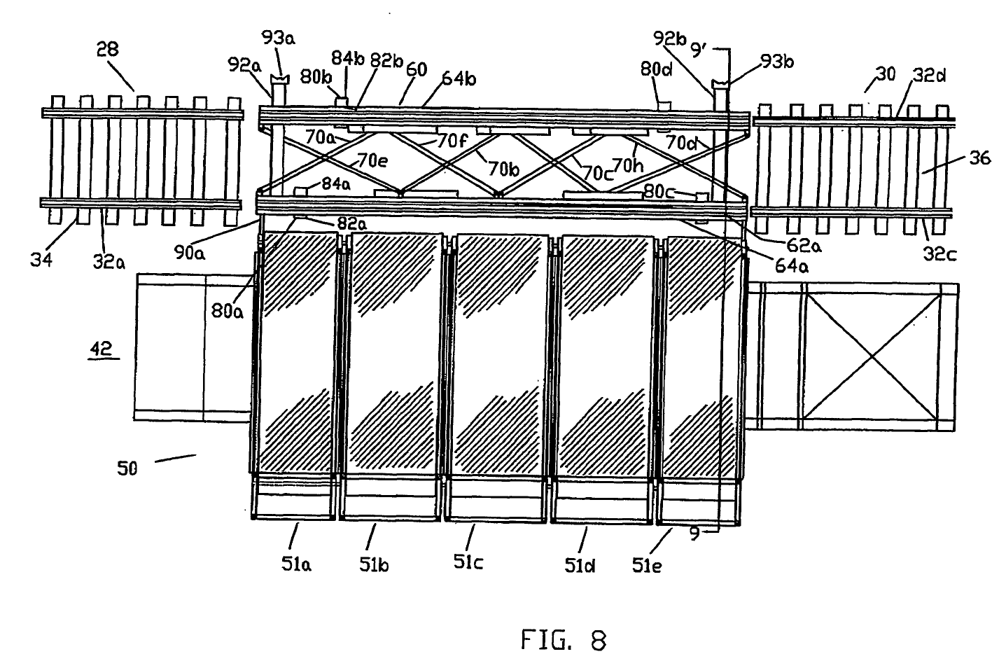

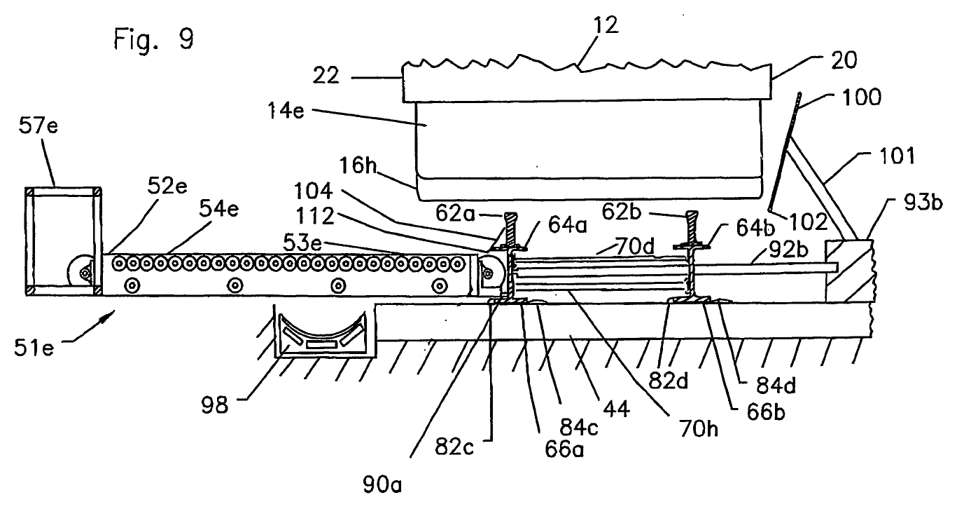

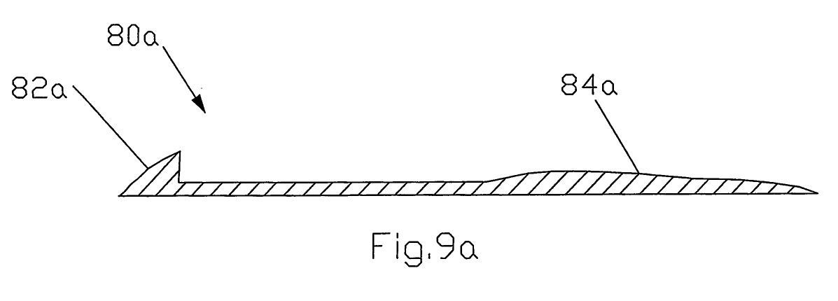

For this exemplary embodiment, an apparatus first position is shown in FIG. 8 and FIG. 9, wherein the receiving deck head 52a-e and tail portions 53a-e are positioned substantially out from under the hoppers 14a-e and the car 12. In this first position, a track member 60, having a first rail 62a with support structure 64a, and a second rail 62b with support structure 64b, is placed between first and second end fixed tracks 28,30, and is of a length such that the track member is between the first end and second end wheel sets 24,26. When so positioned the track member rails align with the fixed track rails 32a-d, such that the car wheel sets can roll onto the track member from the fixed tracks. This occurs as a loaded car 12 is brought into position with its first and second wheel sets straddling the track member 60. In some exemplary embodiments, the support structures 64a-b are steel I-beams, and in some exemplary embodiments, the I-beams run along all or substantially all of the rail 62a-b lengths.

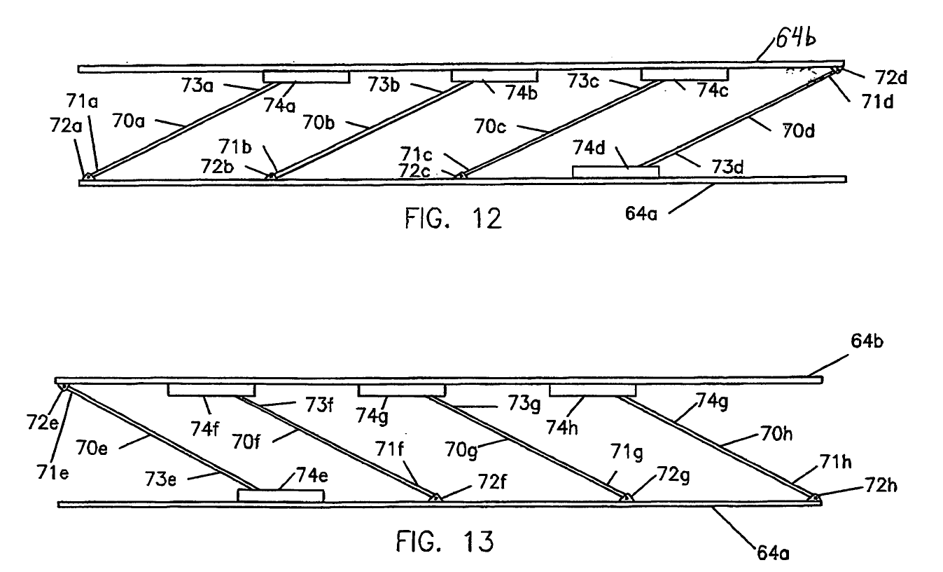

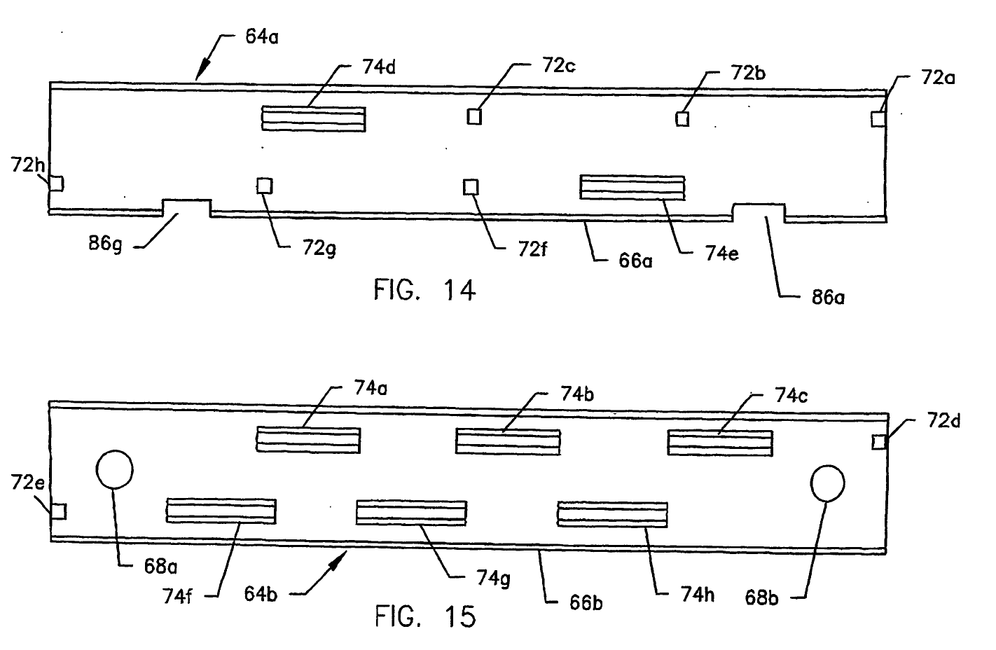

In exemplary embodiments of the type shown in FIGS. 12-15, pull members 70a-h have first ends 71a-h pivotably attached to pivot joints 72a-h on the first and second rail support structures 64a-b, and second ends 73a-h slidably joined to slide channels 74a-h on the first and second rail support structures. Pull members 70a-d are in an upper position with respect to the pull members 70e-h in the lower position, as illustrated for the pull members 70d,70h in FIG. 9. In the apparatus first position (shown in FIGS. 8-9), the pull member second ends have slid to the ends of the slide channels, as illustrated in FIGS. 12-13. As the first rail support structure 64a moves toward the second rail support structure 64b, the pull member second ends 73a-h slide through the slide channels 74a-h, until the rail support structures 64a, 64b contact each other, and finish moving to the second position.

While the apparatus 10 is in the first position, the support structures 64a-b each have a bottom 66a-b that is received by lateral positioners 80a-d, as illustrated in FIGS. 8-9. A sectional view of lateral positioner 80a is depicted in FIG. 9a. The lateral positioners are attached to the base 44 in an offset fashion such that they are not aligned from the car near side 22 to the car far side 20. Each has a first elevation 82a-d, that is substantially vertical and positioned adjacent the first and second rail support structure bottoms 66a-b. Lateral movement of the rail support structure bottoms 66a-b toward the near side of the car 12 is prevented by the first elevation. Each of the lateral positioners also has a second elevation 84a-d that is rounded, such that a substantial, and intended, force can move the rail support structure in the car far side direction. As the rail support structures 64a-b so move, the bottom 66a-b of each is elevated to the height of the second elevation 84a-d, returning to the starting elevation after the lateral positioners have moved toward the car far side a distance sufficient to clear the second elevations 84a-d. As the first rail support structure 64a moves toward the far side of the car, the first rail support structure bottom 66a is notched 86a-b (FIG. 14) twice to clear the two second rail support structure lateral positioners 80b, 80d without substantial contact. In some exemplary embodiments, the pull members and lateral positioners are constructed from steel, while others are constructed from other rigid materials.

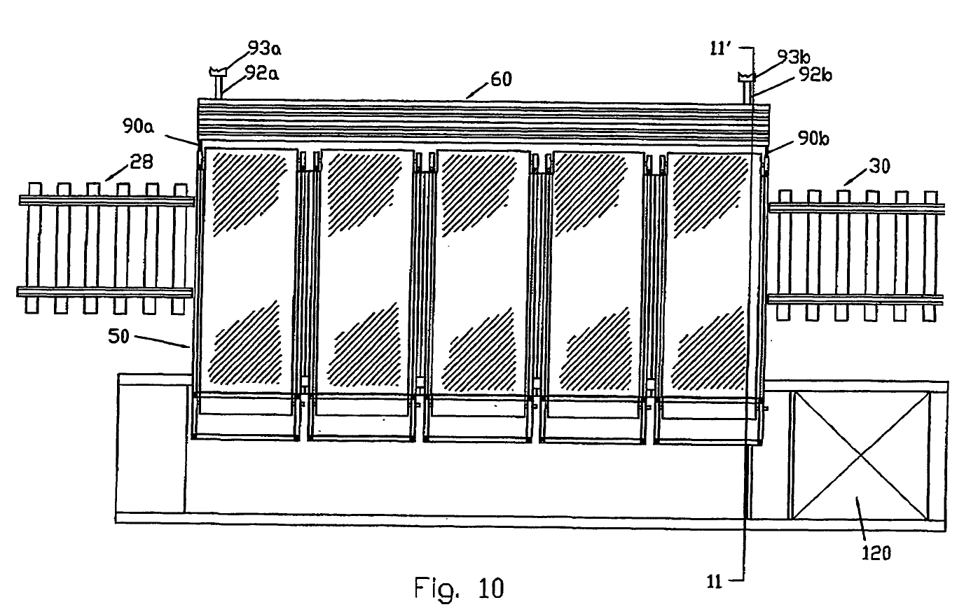

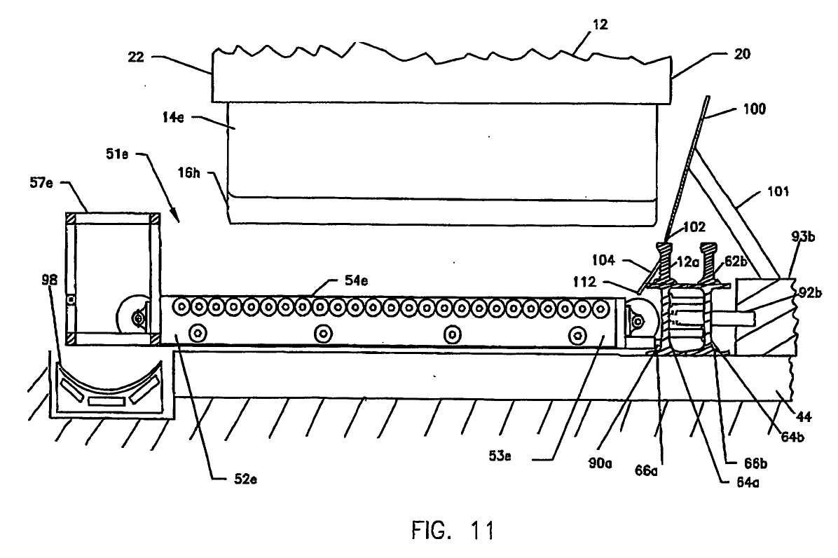

As shown in FIGS. 8-11 for this exemplary embodiment of the apparatus 10, one or more linking mechanisms 90a-b connect the track member 60 with the receiving deck 50. The linking mechanisms attach the first rail support structure 64a to the receiving deck proximate one or more of the conveyor section tail portions 53a-e. In this exemplary embodiment, the apparatus 10 has a second position, wherein the track member 60 is moved to a second position, and the receiving deck is moved to a second position. In some exemplary embodiments of the kind shown in FIGS. 8-11, hydraulic pistons 92a-b, extending from conventional hydraulic power equipment 93a-b, cooperate with the first and second rail support structures 64a-b to pull the track member first and second rails 62a-b, and their respective support structures 64a-b to the second position, as shown in FIGS. 10-11. In some exemplary embodiments, the hydraulic piston extends through openings 68a-b in the second rail support structure 64b, and on to attachment with the first rail support structure 64a. Conventional configurations for the powered displacement of objects such as the first and second rail support structures are also used, including, but not limited to, other hydraulic configurations, as well as, pneumatic configurations and configurations using electric motors.

In such exemplary embodiments, the hydraulic pistons 92a-b pull on the first rail support structure 64a causes the first rail support member bottom 66a to move over the first rail lateral positioner second elevations 84a-b, and also causes the pull member second ends 73a-h to begin sliding in the slide channels 74a-h. Such sliding allows the first and second rail support structures 64a-b to be drawn closer together until the first rail support structure contacts the second. At this point the second rail support structure bottom 66b is then forced over the second rail lateral positioner second elevations 84c-d. Then both the first and second rail support structures are adjacent as they are positioned as shown in FIGS. 10-11. This is the track member 60 second position, where the track member 60 is removed from beneath the hoppers 14a-e and stowed in a collapsed configuration near the car far side 20.

The receiving deck 50 in this exemplary embodiment is pulled to its second position by virtue of its attachment to the first rail support structure 64a, and in this position, the conveyor section tail portions 53a-e are positioned to receive discharged materials from the hoppers 14a-e. As shown in FIGS. 1, the conveyor sections 51a-e are sized and spaced as needed to cover the distance between first end hopper 14a and the second end hopper 14e, with a conveyor section positioned beneath each of the five hoppers 14a-e. The distance between the two wheel sets 24,26 on a typical automatic hopper car is approximately 32 feet (9.75 m). In this exemplary embodiment, the belts 54a-e on each conveyor section 51a-e are approximately five feet (1.5 m) wide, with approximately 15 inches (38.1) between the belts. To prevent discharged materials from entering the space between conveyor sections, generally arch-shaped diverters 94a-d are positioned along and between the two adjacent conveyor sections, and one-half arch-shaped diverters 96a-b are placed along the remaining exposed edge on each of the first conveyor section 5la and the fifth conveyor section 5le, as shown in FIG. 1. The width and arch-shape of the diverters 94a-d and 96a-b redirects discharged materials striking the diverters to the adjacent conveyor sections. For example, some of the material discharged from the hopper 14b will likely strike diverter 94a and be diverted to the first and second conveyor sections 14a-b. Similarly, some of the material discharged from the first end hopper 14a onto the one-half arch-shaped diverter 96a will be diverted to the first conveyor section 51a. In some exemplary embodiments, the diverters 94a-d, 96a-b are made of steel or other sufficiently strong metals, rubber or plastic.

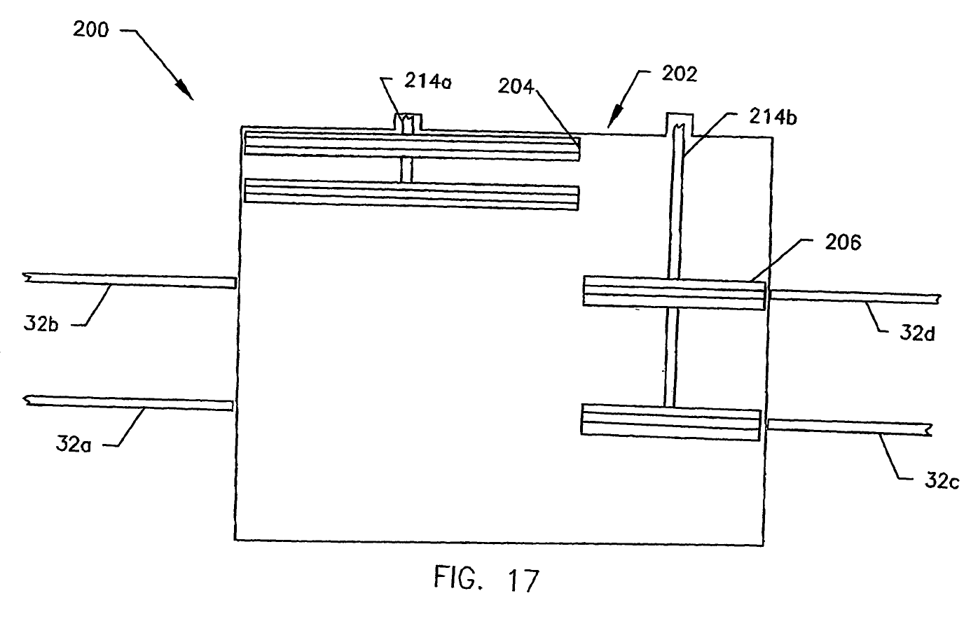

When such an exemplary embodiment is in the second position, the materials discharged through the hoppers 14a-e are received, without obstruction by the now removed track member, on the conveyor section tail portions 53a-e, and are moved to the conveyor section head portions 52a-e for discharge onto a takeaway conveyor 98, as illustrated in FIGS. 10-11. In some exemplary embodiments, the takeaway conveyor is placed substantially parallel to the car 12 and substantially perpendicular to the receiving deck 50, the takeaway conveyor, in some exemplary embodiments, being capable of running in a direction toward either end of the car. In some exemplary embodiments, the takeaway conveyor is approximately 48 inches wide (121.9 cm), and is a roller bed belt conveyor with a concave profile in cross-section, as illustrated in FIG. 3 and FIG. 11. For the installation of the exemplary embodiment depicted in FIG. 16, the surrounding ground level was such that the conveyor section head portions 52a-e discharge the material onto the takeaway conveyor 98 without elevating the conveyor section head portions, although in the embodiment depicted, the apparatus operator obtained this result by recessing the takeaway conveyor a sufficient distance into the surrounding ground 42. In some exemplary embodiments, and in other installations, the first and second end tracks 28,30 are of sufficient elevation that the takeaway conveyor is on top of the ground.

In exemplary embodiments of the type shown in FIG. 9 and FIG. 11, a far side retaining member 100, supported by rigid structure 101, is provided and is positioned along the far side 20 of the car. The far side retaining member has a bottom edge 102 proximate the track member first rail 62a, the bottom edge cooperating positionally with the first rail 62a, as shown in FIG. 11, to direct discharged materials striking the retaining member 100 toward the car near side 22, and onto one or more of the conveyor section tail portions 53a-e. In further cooperation with the first rail 62a, is a lower retaining member 104 attached to the track member 60 such that, when the receiving deck 50 is in the second position, the lower retaining member 102 has a bottom edge 112 that extends to a point proximate one or more of the conveyor section tail portions 53a-e. In such a position, the lower retaining member cooperates with the first rail 62a to direct discharged material striking the lower retaining member 102 toward the car near side 22 and onto one or more of the conveyor section tail portions 53a-e. The lower retaining member 104 and the far side retaining member 100, extend along substantially the entire length of the first rail 62a, thus serving as a retainer for discharged material along substantially the entire length of the receiving deck 50. In some exemplary embodiments, the retaining members 100,102, and the structure 101 are constructed from steel, while in other exemplary embodiments they are constructed from suitable rigid materials.

In some of the embodiments of the type depicted in FIG. 1, first and second baffles 106a-b, are attached to or positioned proximate the first and second one-half arch-shaped diverters 96a-b. The baffles are proximate the first end hopper 14a and second end hopper 14e, respectively, when the receiving deck 50 is in the second position, and the baffles extend from the car near side 22 to the car far side 20, such that the materials discharged from the first end and second end hoppers 14a-e are substantially blocked from passing between the first end hopper 14a and the one-half arch-shaped diverter 96a or the second end hopper 14e and the one-half arch-shaped diverter 96b, such that the materials are discharged onto the first conveyor section 51a and the second conveyor section 51e, respectively. In some exemplary embodiments, the baffles 106a-b are constructed from thick rubber, while in other exemplary embodiments, other thick and resilient materials are used.

In other exemplary embodiments of the kind depicted in FIG. 16, a second apparatus is used with the first to unload two adjacent cars. In such embodiments, the takeaway conveyors discharge the materials into a common conveyor 110, and in other exemplary embodiments the takeaway conveyor is elevated as needed to discharge the materials into other conventional types of receiving devices for material transport, e.g. trucks, trailers, and the like.

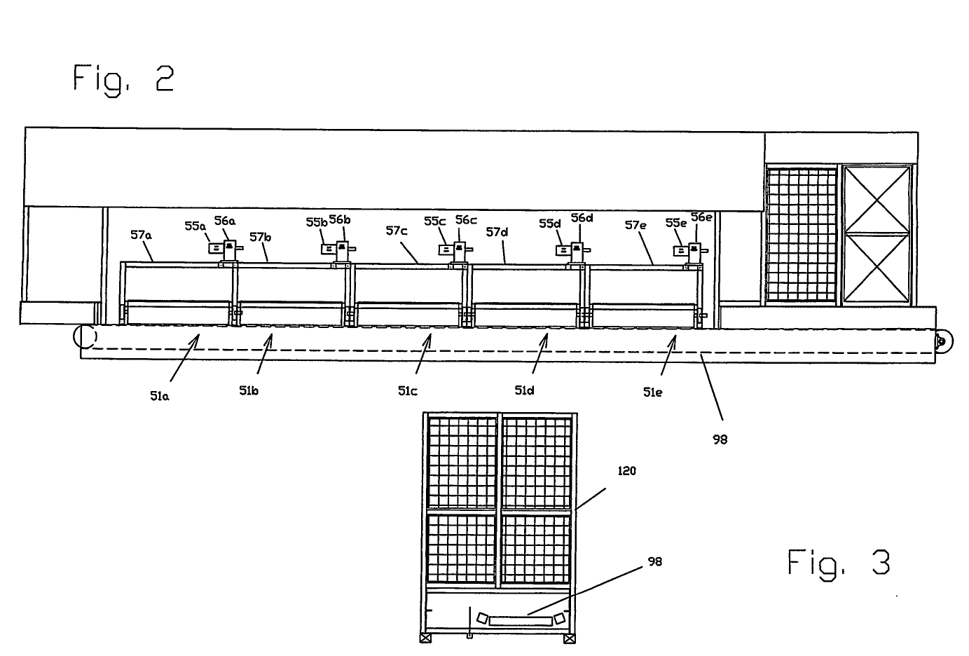

Turning again to FIGS. 2-3, FIG. 8 and FIG. 10, an operator control station 120 is provided including one or more control devices for initiating operation of the conveyor sections 51a-e, and movement of the track member 60 and the receiving deck 50. Conventional control mechanisms are provided for electronic control of the apparatus 10, including but not limited to conventional wiring. In some exemplary embodiments, a computer is provided for receiving input from controlled features of the apparatus, and sending operational commands. In some exemplary embodiments the control devices, operable at the control station, are provided for initiating operation of the takeaway conveyor and controlling the takeaway conveyor speed, for independently initiating the operation of individual conveyor sections 51a-e and regulating the speed of the same, for opening and closing car hoppers 14a-e on cars with electronically controllable hoppers, and for positioning and arresting the car on cars with electronically controllable positioning and arresting capabilities.

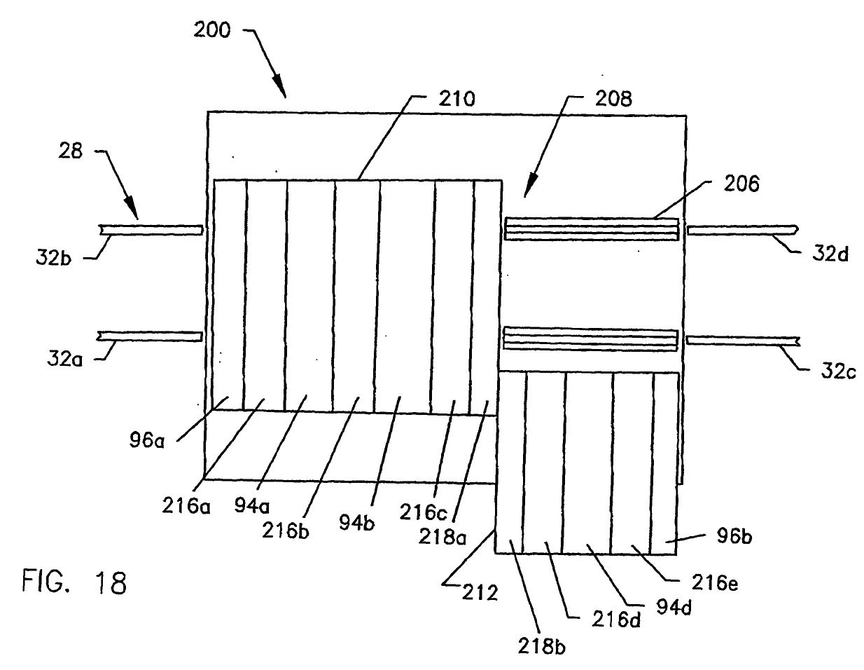

In some exemplary embodiments 200 of the type depicted in FIGS. 17-18, the track member 202 comprises a first section 204 and a second section 206, and the receiving deck 208 comprises a receiving deck first section 210 and a receiving deck second section 212. The rail support structures for the track member first section and the receiving deck first section are connected by pull members similar to those shown in FIGS. 12-15. In such embodiments, the track member first section 204 and the receiving deck first section 210 are movable to the second position while the track member second section 206 and the receiving deck second section 210 remain in the first position. In such exemplary embodiments, the track member second section is capable of supporting the second end wheel set 26. At least one independent hydraulic piston 214a-b is provided for each track member section 204,206, and two additional one-half arch shaped diverters 218a-b are also provided. In such embodiments, the number of conveyor sections 216a-e in the receiving deck first section is three and in the second section two. In other exemplary embodiments, one or more conveyor sections are in each of the receiving deck first and second sections.

In the exemplary embodiment 200 of FIGS. 17-18, the apparatus gains the flexibility to retain, and not deploy, two conveyor sections 216d-e, keeping them and the track member second section 206 in the first position, while deploying the remaining three conveyor sections 216a-c with the track member first section 204. Since conventional cars include those with three hoppers (or three hopper pairs) spaced along the car length, this exemplary embodiment 200 provides exactly the right configuration for three hopper cars, the second wheel set of the three hopper car being supported on the track member second section 206

Similarly, the exemplary embodiment 10 of FIGS. 1-15 is readily modified in an additional exemplary embodiment for a different installation scenario to include only three conveyor sections instead of five, all moving with the receiving deck. In other exemplary embodiments, the total number of conveyor sections is two, and in others, four.

When the exemplary embodiment depicted in FIGS. 1-15 is in use, the apparatus 10 is in the first position as a car 12 loaded with material rolls into position with its first end wheel set 24 positioned on the first end fixed tracks 28, and its second end wheel set 26 positioned on the second end fixed tracks 30. In this position the car straddles the track member 60, which was used as a pair of rails for moving the car over the apparatus. Safety stops 13a-b are inserted to prevent unwanted car movement. While the car is moved into this position the receiving deck 50 is in the first position and in a retracted position, substantially out from beneath the hoppers 14a-e, as shown in FIGS. 8-9.

In such use, the operator, from the control station 120, initiates movement of the apparatus from its first position to its second position. The hydraulic pistons 92a-b pull the track member 60 toward the car far side 20. As the pull begins, the first rail support structure bottom 66a begins to rise over the first rail lateral positioner second elevations 84a-b and the pull member second ends 73a-h begin to slide in the pull member slide channels 74a-h. As the pull continues, the first rail support structure 64a is pulled closer to the second rail support structure 64b. As it contacts the second rail support structure, both the first and second rail support structures are pulled further to the car far side, until the track member 60 is in its second position and the rail support structures 64a-b are in the position shown in FIGS. 10-11.

As the first rail support structure 64a was so moving, the linking mechanisms 90 simultaneously began the deployment of the receiving deck 50 to its second position, by pulling the conveyor section tail portions 53a-e under the hoppers 14a-e. When the track member 60 reaches its second position the receiving deck is in its second position.

In such a position, and as shown on FIG. 11, the far side retaining member bottom 102 is adjacent the first rail 62a. The lower retaining member bottom edge 112 extends to a point near the conveyor section tail portions 56a-e, thus completing the far side retaining wall that includes the far side retaining member 100, the first rail 62a, and the lower retaining member 104, as shown in FIG. 16. For material retention at the receiving deck forward and leading edges, the first and second baffles 106a-b cooperate with the lower ends of the first end hopper 14a and the second end hopper 14b to block the opening between the top of the one-half arch-shaped diverters 96a-b and such hoppers, as shown in FIG. 1.

Once the apparatus is in the second position, the operator initiates the operation of conveyor sections 51a-e, and the takeaway conveyor 98, and opens the hopper doors 16a-h from the control station 120. As the material falls from the hoppers 14a-e onto the conveyor section tail portions 53a-e, the operator adjusts the individual conveyor section speeds as needed to achieve a proper distribution of material on the receiving deck 50, and a proper discharge pattern onto the takeaway conveyor. (In embodiments such as those illustrated by FIG. 16, where a second apparatus 10 is used with the first to unload two cars, the operator will adjust individual conveyor section speeds on both to achieve a proper distribution from the converging takeaway conveyors as they discharge material to the common conveyor 110, a truck, or other material transporter.)

When the last of such material is discharged from the car 12 and deposited onto the takeaway conveyor 98, the operator initiates the hydraulic pistons 92a-b such that they push the first rail support structure 64a toward the car near side 22. As it moves it simultaneously displaces the receiving deck 50 toward the car near side. As the receiving deck moves toward its second position it passes over the takeaway conveyor. As the first rail support structure continues moving toward the car near side, the pull members second ends 73a-h slide in the sliding channels 74a-h to the sliding channel ends. At this point the pull members 70-a-h begin pulling the second rail support structure 64b. As both continue moving toward the car near side 22, the rail support structure bottoms 66a-b are pulled over the first and second rail lateral positioner second elevations 84a-d and into the lateral positioners 80a-d, where they are prevented from further movement toward the car near side 22 by the first and second rail lateral positioner first elevations 82a-d, and by the termination of piston movement. When the rail support structure bottoms 66a-b are so positioned in the lateral positioners 80a-d, the first and second rails 62a-b are aligned with the first and second fixed tracks 28,30. The operator is then free to move the unloaded car forward until the next loaded car is straddling the track member, and then repeat the process.

If an operator is to unload a three hopper car instead of a five hopper car, the exemplary embodiment 200 of FIGS. 17-18 is utilized and the car's first end wheel set 24 is positioned on the first fixed tracks 28, while the second end wheel set 26 is positioned on the track member second section 206. Although the apparatus 200 has five total conveyer sections, only the three on the receiving deck first sub-section 210 are needed. In this example, the operator initiates operation of the hydraulic piston 214a to move the track member first section from its first position (aligned with the fixed tracks 32a-b) to its second position (the position shown in FIG. 17) The track member second section remains in the first position and is supporting the car's second wheel set. As the track member first section moves it pulls the receiving deck first sub-section 210 with its three conveyor sections 216a-c from its first to second position, i.e. under the three hoppers. The receiving deck second sub-section remains in place, out from under the hoppers, as shown in FIG. 18.

In this three hopper car example, once the receiving deck first sub-section is in its second position, the operator again initiates the conveyors and opens the hopper's doors from the control station. When the car is unloaded, the operator initiates the operation of the hydraulic piston 214a and returns both the track member first section 204 and the receiving deck first sub-section 210 back to their first positions from the second positions. In this second position, the track member first and second sections 204,206 are again aligned with the fixed tracks 32a-b for car passage over the apparatus.

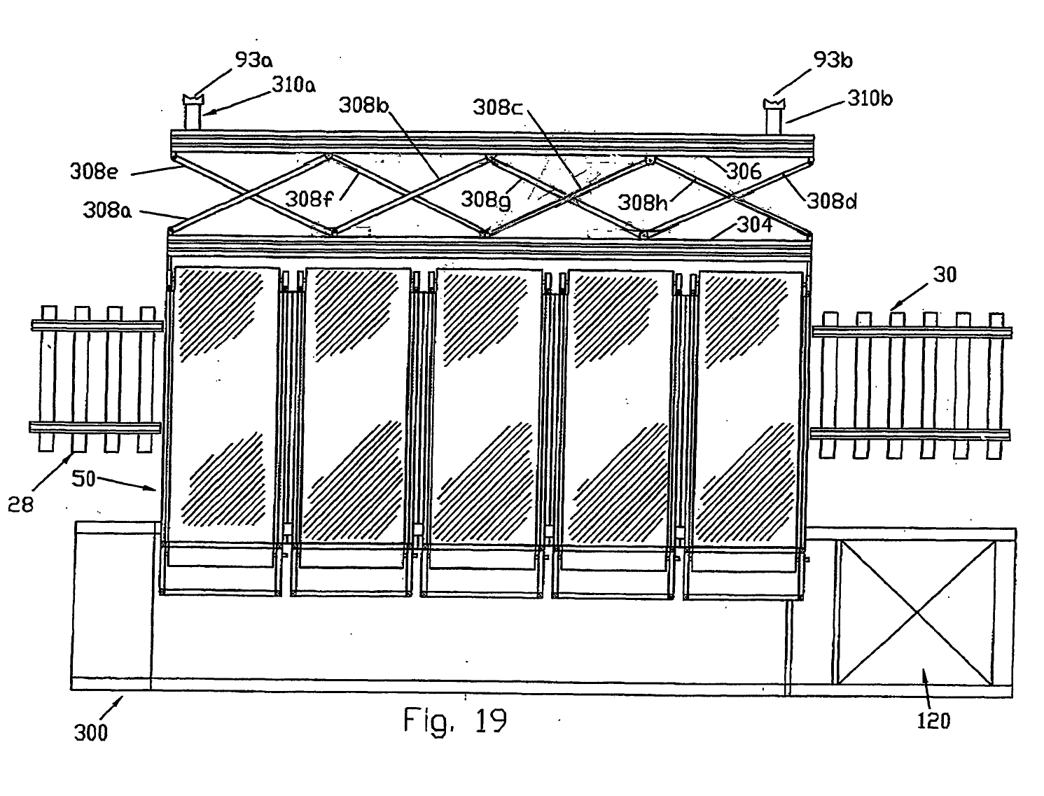

In another exemplary embodiment 300, the distance between the first and second rail support structures 304,306 on the track member 302 is fixed in the manner shown in FIG. 19. In such an embodiment, rail support structures maintain this distance as both are moved out from under the hopper car into the second position. Non-sliding, fixed pull members 308a-h, are used in some such embodiments for the purpose of maintaining the fixed distance between the rail support structures. In some such embodiments, hydraulic pistons 310a-b are attached to the second rail support structure 306.

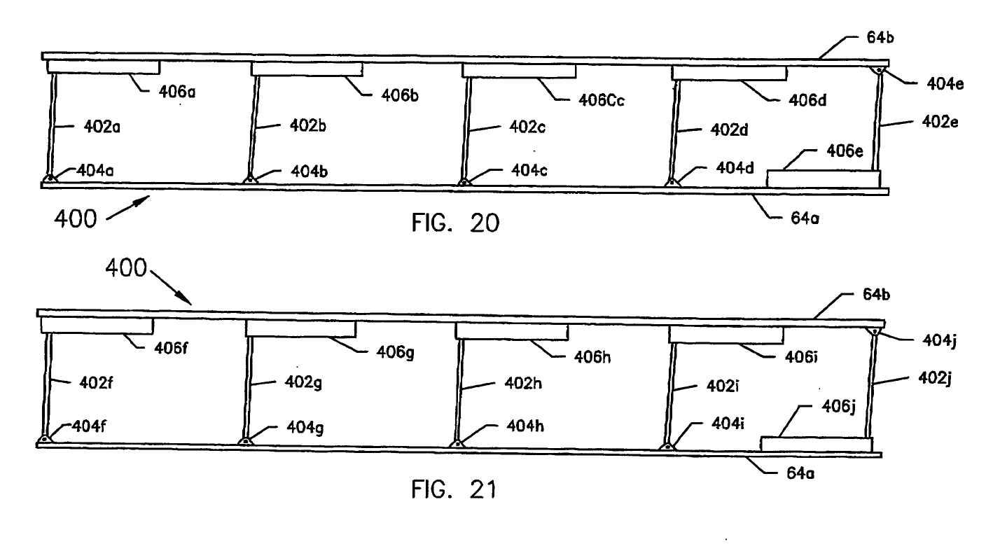

In another exemplary embodiment 400, pull members 402a-j are configured as illustrated in FIGS. 20-21, such that, when the track member is in the first position the pull members are perpendicular or substantially perpendicular to the rail support structures. Such pull members are slidable in a manner similar to pull members 70a-h, shown in FIGS. 9-10 and FIGS. 12-13, using pin joints 404a-j and slide channels 406a-j.

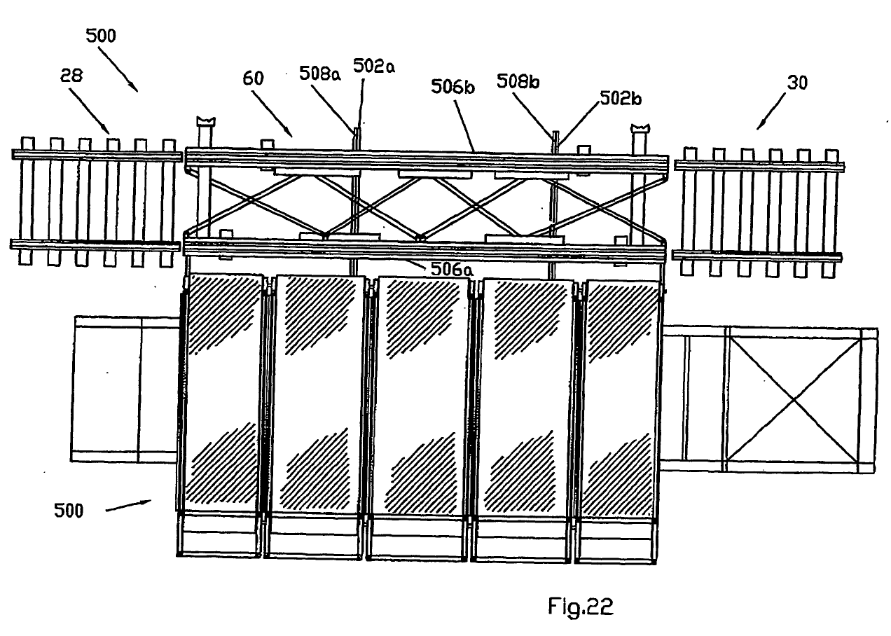

Another exemplary embodiment 500, shown in FIG. 22, provides guide tracks 502a-b for guiding and enhancing the movement of track member 504 from the first to the second position. In some such embodiments, the rail support structures 506a-b extend into grooves 508a-b in the guide tracks 502a-b.

With respect to the above description then, it is to be realized that the optimum device configuration for the particular situation, will include variations in the device shape, size, and component materials, that will occur to those skilled in the art upon review of the present disclosure.

All equivalent relationships to those illustrated in the drawings and described in the specification are intended to be encompassed by the present invention. The descriptions in this specification are for purposes of illustration only and are not to be construed in a limiting sense.

I claim:

1. A hopper car unloading apparatus for transporting materials discharged through hoppers on a rail hopper car, the car having a first end wheel set and a second end wheel set, the wheel sets being positionable on fixed tracks adjacent the apparatus, the apparatus comprising:
a movable track member, the track member being movable from and to an aligned position wherein the track member is aligned with the fixed tracks such that the car wheel sets are rollable over the track member; and
a receiving deck having a head portion, the receiving deck being movable to and from a receiving position beneath the car for receiving the materials discharged through the hoppers, the receiving deck transporting such received materials from beneath the car for discharge at the head portion, the track member being out of its aligned position when the receiving deck is in the receiving position.

2. A hopper car unloading apparatus for transporting materials discharged through hoppers on a rail hopper car, the car having a first end wheel set and a second end wheel set, the wheel sets being positionable on fixed tracks adjacent the apparatus, the apparatus comprising:
a track member, the track member being between the first end and second end wheel sets, the track member being movable from a first position in which the track member is substantially aligned with the fixed tracks such that the car wheel sets can roll onto the track member from the fixed tracks, to a second position, such that the track member is substantially out from under the hoppers; and
a receiving deck, the receiving deck having a head portion, the receiving deck being movable from a first position to a second position, wherein at least part of the receiving deck is beneath at least one hopper along substantially the entire at least one hopper length, the receiving deck and the track member cooperating for coordinated movement between the first and second positions of each;
such that, when the track member is in the second position and materials are discharged through the at least one hopper above the receiving deck, the materials are transported by the receiving deck for discharge at the receiving deck head portion.

3. The apparatus of claim 2, wherein the receiving deck further comprises at least two conveyor sections.

4. The apparatus of claim 2, wherein the track member further comprises at least two sections, and the receiving deck further comprises at least two sections, each track member section cooperating with a receiving deck section, for coordinated movement between the first and second positions of each, the movement being optionally independent of movement by other track member sections and other receiving deck sections.

5. The apparatus of claim 4, wherein each receiving deck section further comprises at least two conveyor sections.

6. The apparatus of claim 2, further comprising a takeaway conveyor, the takeaway conveyor being positioned to receive materials discharged at the receiving deck head portion.

7. The apparatus of claim 6, further comprising a second like apparatus positioned for receiving discharged materials from a second rail hopper car's hoppers, the takeaway conveyor for each apparatus discharging received materials onto a common conveyor.

8. The apparatus of claim 2, further comprising electronic control of the coordinated movement of the track member and the receiving deck.

9. The apparatus of claim 8, further comprising an operator control station from which an operator operates the electronic control of the coordinated movement of the track member and the receiving deck.

10 The apparatus of claim 2, wherein, while the receiving deck is in the second position, the at least one hopper above the receiving deck is a paired hopper, and at least part of the receiving deck is beneath substantially the entire combined length of the paired hoppers.

11. The apparatus of claim 2, wherein the track member has a first rail and a second rail, each rail for receiving the car wheel sets, the first rail and second rail being moved closer together when the track member is moved from the first position.

12. A hopper car unloading apparatus for transporting materials discharged through hoppers on a rail hopper car, the car having a first end wheel set and a second end wheel set, the wheel sets being positionable on fixed tracks adjacent the apparatus, the apparatus comprising:
a movable track member;
means for moving the track member from and to an aligned position wherein the track member is aligned with the fixed tracks such that the car wheel sets are rollable over the track member;
a receiving deck having a head portion; and means for moving the receiving deck to and from a receiving position beneath the car for receiving the materials discharged through the hoppers, the receiving deck transporting such received materials from beneath the car for discharge at the head portion, the track member being out of its aligned position when the receiving deck is in the receiving position.

13. A hopper car unloading apparatus for transporting materials discharged through hoppers on a rail hopper car, the car having a first end wheel set and a second end wheel set, the wheel sets being positionable on fixed tracks adjacent the apparatus, the apparatus comprising:
a track member, the track member being between the first end and second end wheel sets;
means for moving the track member a first position in which the track member is substantially aligned with the fixed tracks such that the car wheel sets can roll onto the track member from the fixed tracks, to a second position such that the track member is substantially out from under the hoppers;
a receiving deck, the receiving deck having a head portion; and
means for moving the receiving deck from a first position to a second position wherein at least part of the receiving deck is beneath at least one hopper along substantially the entire at least one hopper length, the means for moving the receiving deck and the means for moving the track member cooperating for coordinated movement of the receiving deck and the track member between the first and second positions of each;
such that when the track member is in the second position and materials are discharged through the at least one hopper above the receiving deck, the materials are transported by the receiving deck for discharge at the receiving deck head portion.

14. The apparatus of claim 13, wherein the means for moving the receiving deck is a direct linkage of the receiving deck to the track member.

15. A method for transporting materials discharged through hoppers on a rail hopper car, the car having a first end wheel set and a second end wheel set, the wheel sets being positionable on fixed tracks adjacent the apparatus, the method comprising the steps of:
positioning the car on the fixed tracks while the track member is in an aligned position wherein it is aligned with the fixed tracks, such that the car wheel sets are rollable over the track member, the car wheels utilizing the track member for such positioning;
moving the track member to a non-aligned position;
moving a receiving deck, having a head portion, to a receiving position beneath the car;
receiving materials discharged through the at least one hopper onto the receiving deck;
transporting the discharged materials on the receiving deck for discharge at the receiving deck head portion;
removing the receiving deck from its receiving position;
returning the track member to its aligned position; and
moving the hopper car from above the track member, the hopper car wheels utilizing the track member during such movement.

16. The method of claim 15, wherein a second car is coupled to the unloaded car, the method further comprising repeating the steps of claim 15 for the second car, the step of positioning the car on the fixed tracks occurring as the first car was removed from above the track member.

17. The method of claim 15, further comprising the step of receiving the discharged materials from the receiving deck onto a takeaway conveyor.

18. A method for transporting materials discharged through hoppers on a rail hopper car, the car having a first end wheel set and a second end wheel set, the wheel sets being positionable on fixed tracks adjacent the apparatus, the method comprising the steps of:
positioning the car on the fixed tracks such that the car hoppers are above a track member, the track member being movable from first position under the hoppers to a second position substantially out from under the hoppers, the car wheels utilizing the track member for such positioning;
moving the track member to the second position;
moving a receiving deck, having a head portion, from a first position wherein the receiving deck is substantially out from under the hoppers, to a second position wherein at least part of the receiving deck is beneath at least one hopper along substantially the entire hopper length;
receiving materials discharged through the at least one hopper onto the receiving deck; transporting the discharged materials on the receiving deck for discharge at the receiving deck head portion;
returning the receiving deck to its first position;
returning the track member to the first position; and
moving the hopper car from above the track member, the hopper car wheels utilizing the track member during such movement.

19. The method of claim 18, wherein a second car is coupled to the unloaded car, the method further comprising repeating the steps of claim 18 for the second car, the step of positioning the car on the fixed tracks occurring as the first car was removed from above the track member.

20. The method of claim 18, further comprising the step of receiving the discharged materials from the receiving deck onto a takeaway conveyor.
